(19) United States
(12) Patent Application Publication
(10) Pub. No.: US 2021/0315295 A1
(43) Pub. Date: Oct. 14, 2021

(54) Face Covering

(71) Applicant: WinCraft, Incorporated, Winona, MN (US)

(72) Inventor: Christopher A. Jackson, Coon Valley, WI (US)

(73) Assignee: WinCraft, Incorporated, Winona, MN (US)

(21) Appl. No.: 17/229,407

(22) Filed: Apr. 13, 2021

Related U.S. Application Data
(60) Provisional application No. 63/009,440, filed on Apr. 13, 2020.
(60) Provisional application No. 63/037,720, filed on Jun. 11, 2020.

(51) Int. Cl. A41D 13/11; A41D 27/08; G09F 21/02

(52) U.S. Cl. CPC A41D 13/1161; A41D 27/08; A41D 2500/30; A41D 2500/20; G09F 21/023

(57) ABSTRACT

A face covering made from a single piece of fabric material includes a planar body portion that has a lower portion configured to cover a mouth and nose of a user and an upper portion configured to fold behind the lower portion. A first ear panel extends laterally away from the planar body portion along a first direction, and a second ear panel extends laterally away from the planar body portion along a second direction.

### CROSS-REFERENCE TO RELATED APPLICATIONS

This application claims the benefit of U.S. Provisional Patent Application No. 63/009,440 filed Apr. 13, 2020, entitled “Face Mask”, and U.S. Provisional Patent Application No. 63/037,720 filed Jun. 11, 2020, entitled “Face Mask”, each of which is incorporated by reference herein in its entirety.

### BACKGROUND OF THE INVENTION

Various face coverings are known in the art for industrial purposes (e.g., helping to prevent the wearer from being exposed to dust, particles or odors) or fashion purposes. The present disclosure improves upon the state of the art, as set forth herein.

### BRIEF SUMMARY OF THE INVENTION

The disclosed embodiments improve upon and add to embodiments in the prior art. For example, in some implementations, a face covering is provided that is preferably made from a single piece of fabric material that may be made without conducting a sewing operation, although the disclosure is not so limited and other embodiments are contemplated.

The face covering preferably includes a planar body portion having a lower portion to cover a mouth and nose of a user and an upper portion to fold behind the lower portion to provide two layers of filtration to the user. The face covering optionally includes a first tie extending laterally away from the planar body portion along a first direction, and a second tie extending laterally away from the planar body portion along a second direction, wherein the second direction is generally opposite to the first direction. The face covering also includes a first ear panel extending laterally away from the planar body portion along a third direction, and a second ear panel extending laterally away from the planar body portion along a fourth direction.

In one embodiment there is a face covering made from a single piece of fabric material including a planar body portion having a lower portion configured to cover a mouth and nose of a user and an upper portion configured to fold behind the lower portion. The face covering includes a first ear panel extending laterally away from the planar body portion along a first direction, and a second ear panel extending laterally away from the planar body portion along a second direction. In some embodiments, each ear panel defines at least one opening therethrough to facilitate fitting each said ear panel over an ear of the user. In some embodiments, the face covering further includes first indicia printed thereon that explains how to put on the face covering. In some embodiments, the first indicia is positioned on the upper portion of the planar body portion such that the first indicia is at least partially obscured when the user is wearing the face covering.

In some embodiments, the face covering further includes second indicia located on the lower portion of the planar body portion. In some embodiments, the second indicia and first indicia are printed on the same face of the planar body portion. In some embodiments, the second indicia and first indicia are printed on opposite faces of the planar body portion. In some embodiments, the second indicia includes advertising material. In some embodiments, the second indicia includes a graphic design. In some embodiments, the second indicia includes a graphic design of a face. In some embodiments, each ear panel defines a plurality of openings therethrough to facilitate fitting each said ear panel over an ear of the user. In some embodiments, at least one of the openings defined through each ear panel is formed as a slit cut through the ear panel.

In some embodiments, the fabric material includes elastic material. In some embodiments, the fabric material includes a woven fabric material. In some embodiments, the fabric material includes a non-woven fabric material. In some embodiments, the face covering further includes a first tie extending laterally away from the planar body portion along a first direction, and a second tie extending laterally away from the planar body portion along a second direction, the second direction being generally opposite to the first direction. In another embodiment, there is a method of making the face covering, the method including supplying fabric material, and cutting out a blank from the fabric material, the blank having a shape of the planar body portion, the first ear panel, and the second ear panel. In some embodiments, the cutting out the blank is carried out by way of die cutting operation. In some embodiments, the method further includes printing indicia on at least a portion of the blank.

### BRIEF DESCRIPTION OF THE SEVERAL VIEWS OF THE DRAWINGS

The foregoing summary, as well as the following detailed description of embodiments of the face covering, will be better understood when read in conjunction with the appended drawings of an exemplary embodiment. It should be understood, however, that the invention is not limited to the precise arrangements and instrumentalities shown.

FIG. 1 is a front plan view of a face covering in accordance with an exemplary embodiment of the present disclosure;

FIG. 2 is an enlarged view of a portion of the face covering of FIG. 1;

FIG. 3 is a view of selected indicia that may be printed on a face covering in accordance with the present disclosure;

FIGS. 4A-4F illustrate sequential steps of a process of putting on a face covering in accordance with an exemplary embodiment of the present disclosure;

FIGS. 5A-5C are various views of a user wearing a face covering made in accordance with an exemplary embodiment of the present disclosure; and

FIGS. 6A-6B are front plan views of another face covering in accordance with an exemplary embodiment of the present disclosure.

### DETAILED DESCRIPTION OF THE EXEMPLARY EMBODIMENTS OF THE INVENTION

The present disclosure provides face coverings and methods for making the same. In some implementations, the disclosed face covering may be made from a single piece of fabric material. However, it will be appreciated that, in other embodiments, the face covering may be made from two or more pieces of material that may be sewn together, or adhered to each other using an adhesive, or joined using other techniques such as by ultrasonic welding. However, in one embodiment, the disclosed face covering is made from a single piece of material that may be printed with indicia thereon. The face covering may alternatively be referred to as a face mask or face veil.

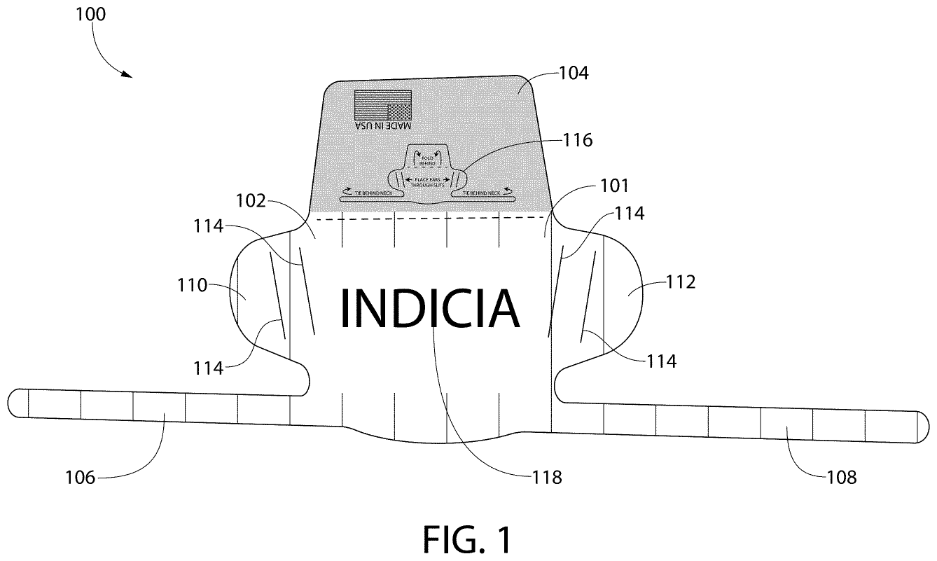

For purposes of illustration, and not limitation, FIGS. 1-3 illustrate a first exemplary embodiment of a face covering, generally designated 100, in accordance with the disclosure, or components thereof. As illustrated in FIG. 1, a face covering 100 is provided that may be made from a single piece of fabric material. The pattern may be altered from what is illustrated to the extent needed to accomplish a particular application, and the disclosed shape of the fabric blank is merely illustrative. The fabric may be cut from a piece of material using any desired automated technique (automated pattern transfer to an automated cutting table, die cutting, and the like) or manual techniques as are known in the art.

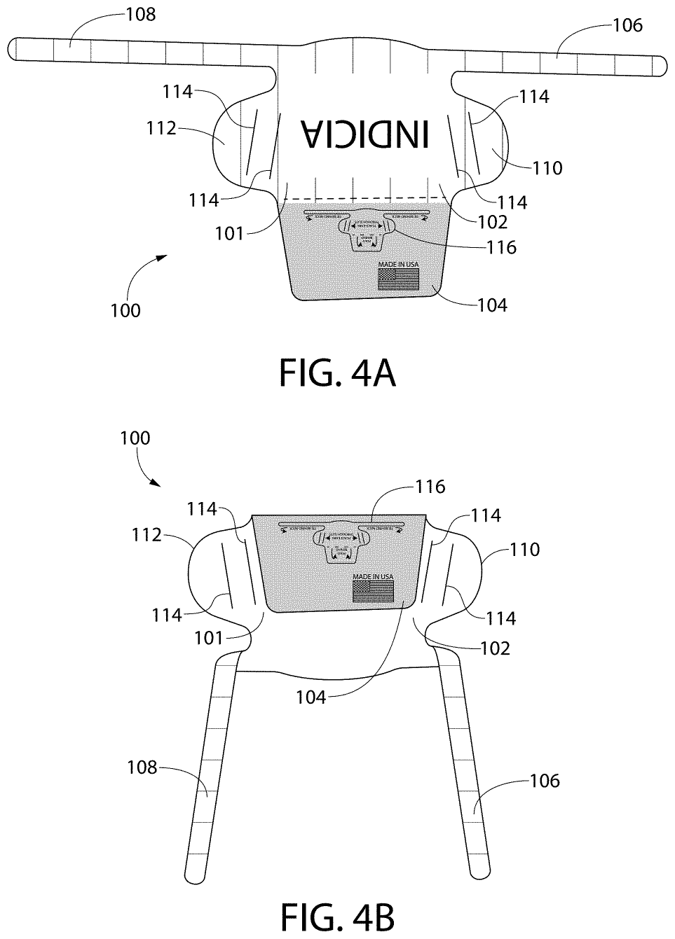

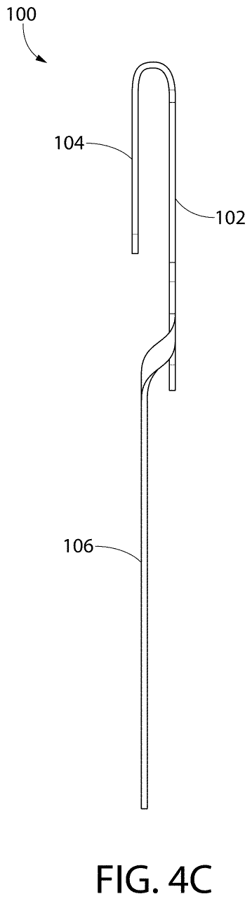

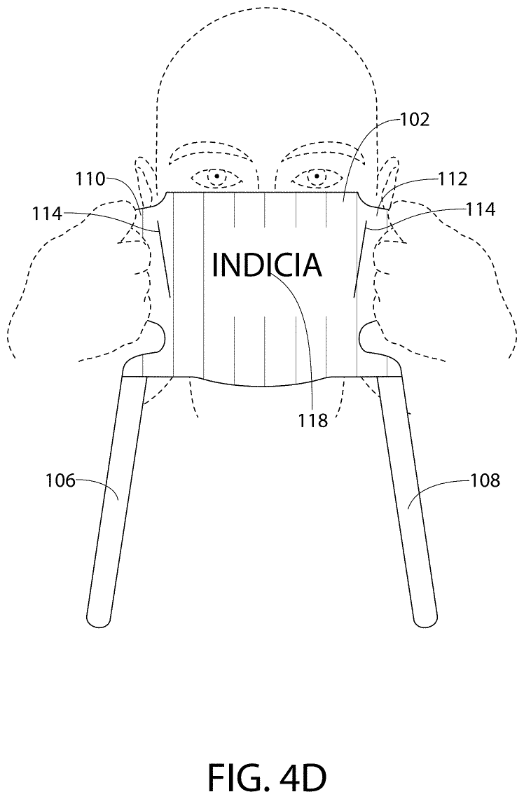

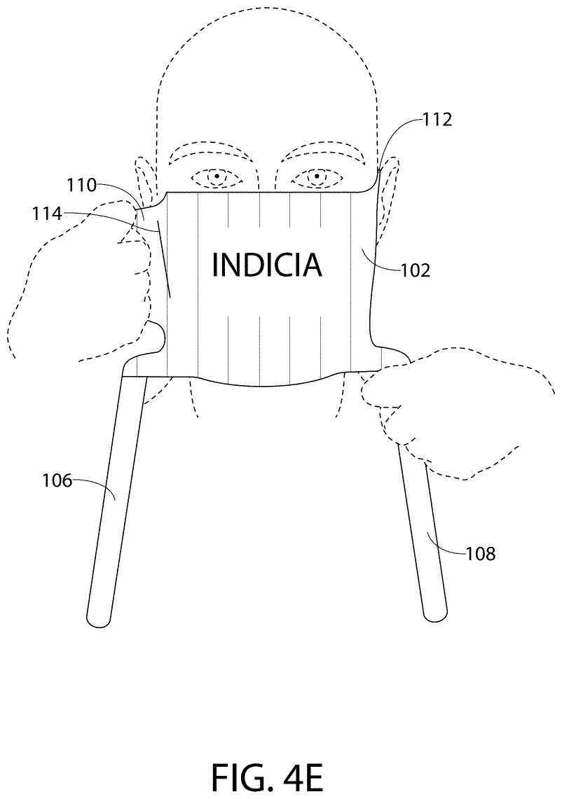

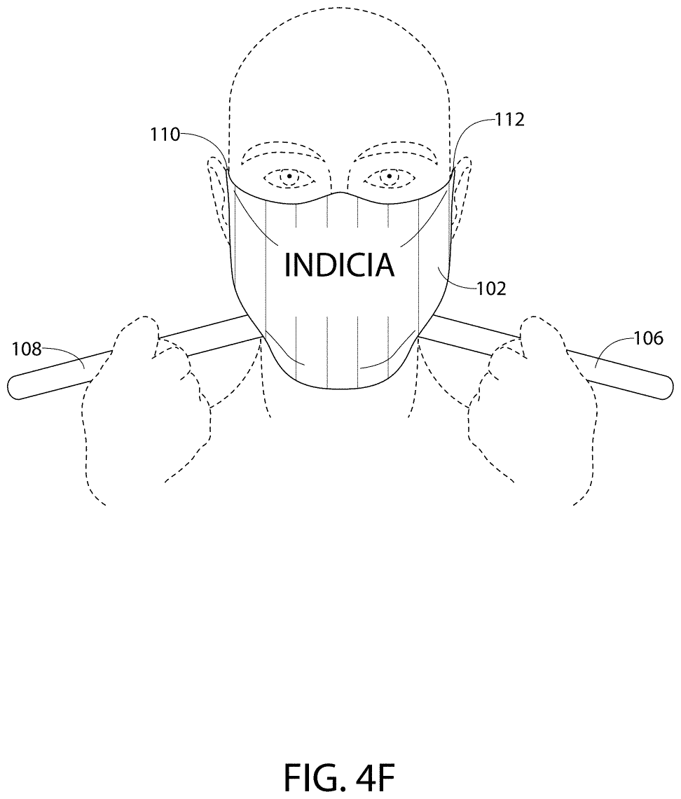

As illustrated, the face covering 100 preferably includes a planar body portion 101 having a lower portion 102 to cover a mouth and nose of a user and an upper portion 104 to fold behind the lower portion 102 (as shown in FIG. 4B) to provide two layers of fabric to provide filtration to the user. If desired, adhesive patches (not shown) may be provided to hold the upper portion 104 and lower portion 102 of the face covering 100 together when the upper portion 104 is folded over. Moreover, if desired, a reusable or disposable filter paper (not shown) may be inserted between the layers of fabric when used. The face covering 100 may be reusable. In one embodiment, the face covering is washable. In one embodiment, the face covering is machine washable.

As further illustrated in FIG. 1, the face covering 100 optionally includes a first tie 106 extending laterally away from the planar body portion 101 along a first direction to the left, and a second tie 108 extending laterally away from the planar body portion along a second direction to the right. As discussed below, the ties 106 and 108 may be tied together behind the neck of the user, or they may be clipped together, as desired.

As further disclosed in FIG. 1, the face covering 100 may include a first ear panel 110 extending laterally away from the planar body portion along a leftward direction, and a second ear panel 112 extending laterally away from the planar body portion along a rightward direction. As illustrated, each ear panel 110 and 112 may define at least one opening 114 therethrough to facilitate fitting each said ear panel 110 and 112 over an ear of the user. In the illustrated embodiments, two ear openings 114 are provided on each side that are angled outwardly with respect to a centerline of the face covering. In some embodiments, the openings 114 are slits in each respective ear panel 110 and 112.

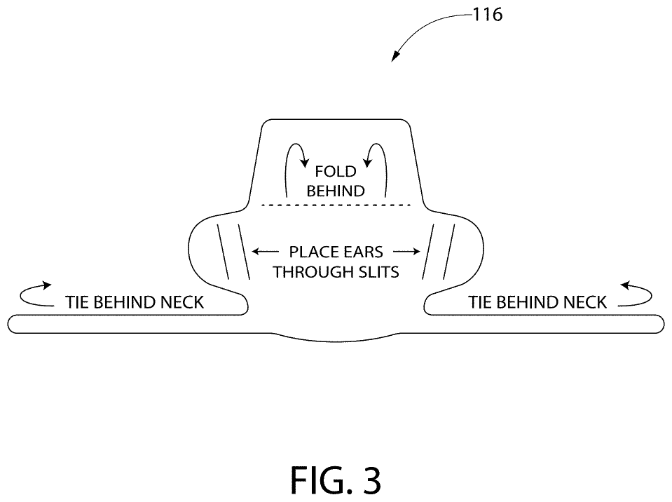

As further disclosed in FIG. 1, the face covering may be provided with first indicia 116 on the upper portion 104 of the planar body portion 101 for putting on and using the face covering 100. This is shown in FIG. 3. As illustrated, the first indicia 116 is located on the upper portion 104 of the planar body portion 101 so that the first indicia 116 is at least partially obscured when the user is wearing the face covering 100.

The face covering may also be provided with second indicia 118 on the lower portion 102 of the planar body portion 101. If desired, the first indicia 116 and second indicia 118 may be printed on the same face of the planar body portion 101 to facilitate manufacture. However, if desired, the second indicia 118 and first indicia 116 may be printed on opposite faces of the planar body portion 101. If desired, the first indicia 116 or second indicia 118 may include one or more of instructions, advertising material, a graphic design (such as a logo or trademark, a name or phrase, the graphic design of a face, and/or a comic book character or decorative face covering, and the like).

The face covering 100 may be made from a variety of different materials. In some embodiments, the material may be substantially inelastic, such as non-woven materials sold under the trade name of Kimguard™ sold by Kimberly Clark, Inc. and the like. In other implementations, the fabric material used to make the face covering 100 may include elastic material so that the face covering 100 conforms to the shape of the user's face (e.g., fabric including lycra or elastane fibers). Thus, the fabric may include a woven or non-woven material, as desired. The face covering 100 may be made from a blend of polyester and spandex materials. In one embodiment, the face covering 100 is comprised of approximately 80% polyester and approximately 20% spandex. In one embodiment, the face covering is comprised of approximately 82% polyester and approximately 18% spandex. In some implementations, the fabric may include an elastic or elastomeric non-woven fabric material. For example, non-woven fabric utilizing elastomeric spunbond material can be used as described in one or more patents owned by Kraton Polymers U.S. LLC (Houston, Tex.) Inc., including for example U.S. Pat. Nos. 8,003,209, 7,662,323, 7,268,184, 7,910,208, 7,439,301, 6,825,274, 7,048,979, 6,537,661, each of which is hereby incorporated by reference in its entirety.

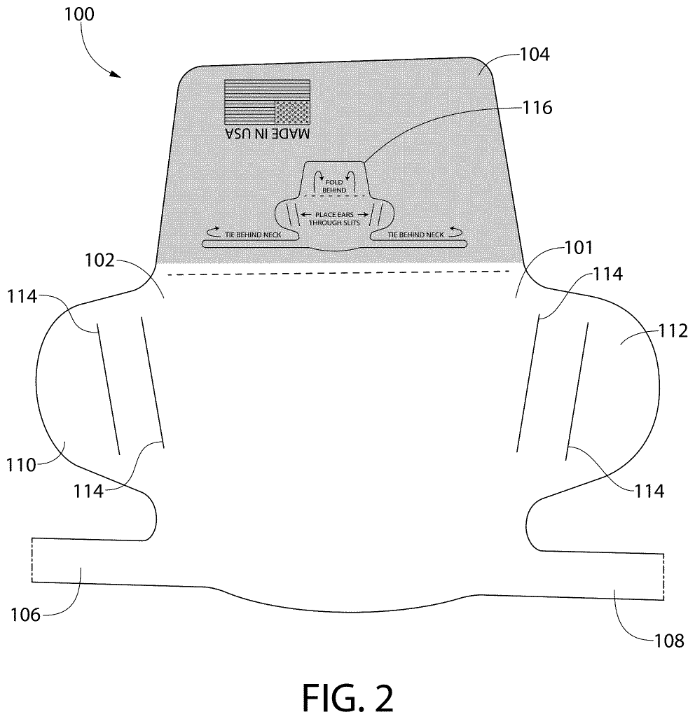

FIG. 2. illustrates a close-up view of a central portion of the face covering 100 of FIG. 1. As illustrated, the upper portion 104, or flap, of the face covering 100 includes first indicia 116 for using the face covering 100 that is more visible in FIG. 3. In some embodiments, the “Tie Behind Neck” indicia may be positioned within the indicia representing the first and second ties. With reference to FIGS. 4A-4E, FIG. 4A illustrates the face covering 100 in an inverted configuration. Decorative indicia (e.g., second indicia 118) may be provided on the front of the face covering 100, as indicated. FIG. 4B illustrates folding the upper portion 104, which includes the first indicia 116, over. The upper portion 104 may be configured to contact the user's nose and mouth when the face covering is worn by the user. FIG. 4C illustrates a side view of the face covering 100 as shown in FIG. 4B with the upper portion 104 folded over.

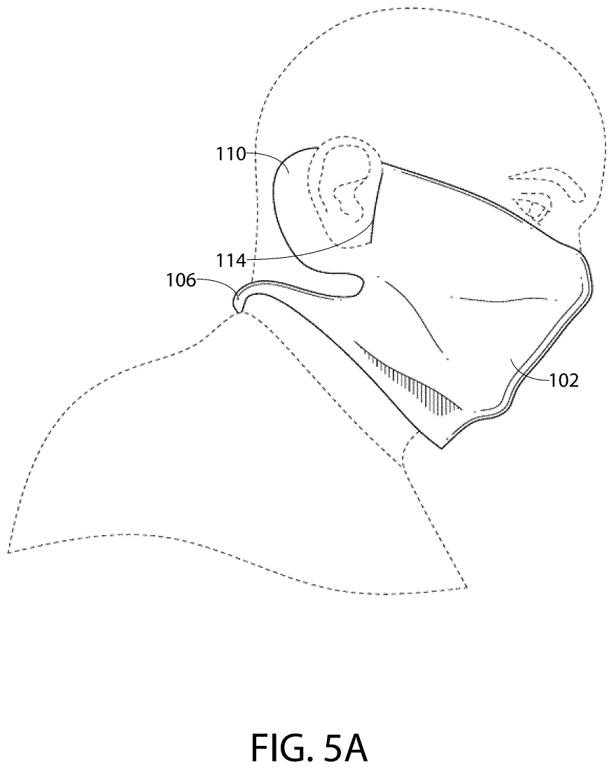

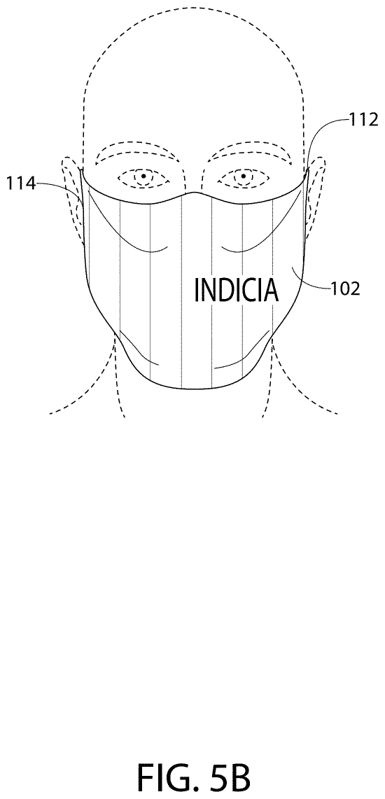

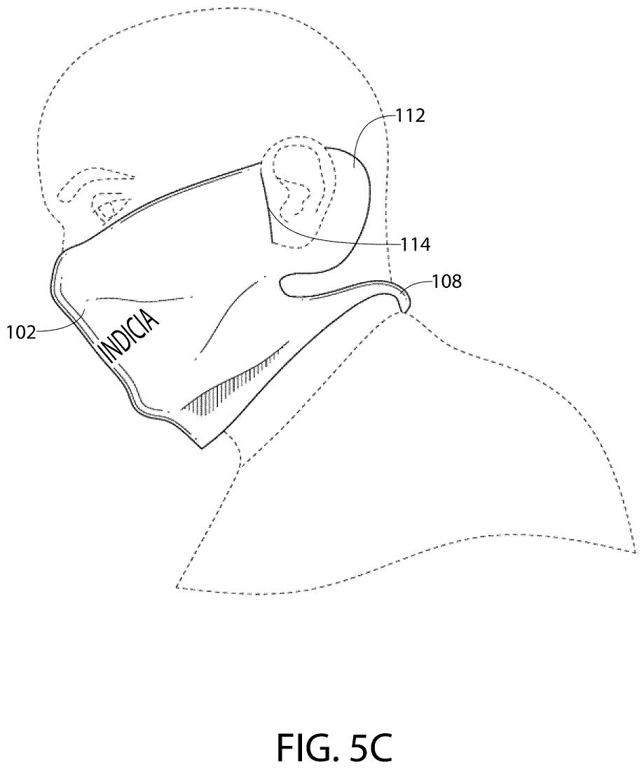

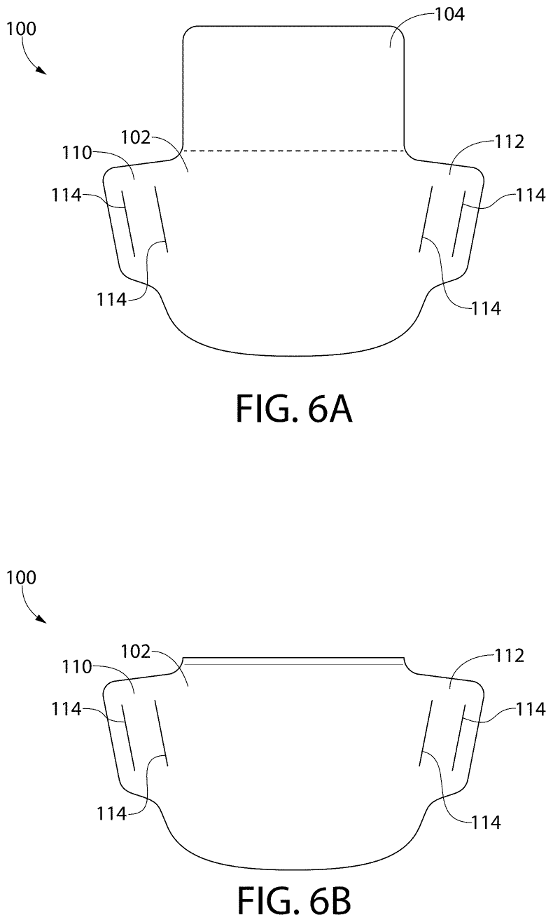

FIG. 4D illustrates the user reversing the orientation of the face covering 100 such that the upper portion 104 including the first indicia 116 faces the user and covers their nose and mouth. FIG. 4E illustrates the face covering 100 after an opening 114 in ear panel 112 has been pulled over the user's ears, partially holding the face covering 100 in place. Next, as illustrated in FIG. 4F, the user grabs each tie portion 106 and 108 (if present) and ties them in a knot behind the user's neck. The illustrated embodiment may be made from a material with some elasticity, such that it conforms to at least a portion of the user's face as illustrated in FIGS. 5A-5C. FIGS. 6A and 6B illustrate an embodiment of face covering 100 wherein the tie portions 106 and 108 are not provided.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. The words “right”, “left”, “lower” and “upper” designate directions in the drawings to which reference is made. The words “inwardly” and “outwardly” refer to directions toward and away from, respectively, the geometric center of the face covering. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A face covering made from a single piece of fabric material comprising:
a planar body portion having a lower portion configured to cover a mouth and nose of a user and an upper portion configured to fold behind the lower portion;
a first ear panel extending laterally away from the planar body portion along a first direction; and
a second ear panel extending laterally away from the planar body portion along a second direction.

2. The face covering of claim 1, wherein each ear panel defines at least one opening therethrough to facilitate fitting each said ear panel over an ear of the user.

3. The face covering of claim 1 further comprising:
a first indicia printed thereon that explains how to put on the face covering.

4. The face covering of claim 3, wherein the first indicia is positioned on the upper portion of the planar body portion such that the first indicia is at least partially obscured when the user is wearing the face covering.

5. The face covering of claim 4 further comprising:
second indicia located on the lower portion of the planar body portion.

6. The face covering of claim 5, wherein the second indicia and first indicia are printed on the same face of the planar body portion.

7. The face covering of claim 5, wherein the second indicia and first indicia are printed on opposite faces of the planar body portion.

8. The face covering of claim 5, wherein the second indicia includes advertising material.

9. The face covering of claim 5, wherein the second indicia includes a graphic design.

10. The face covering of claim 5, wherein the second indicia includes a graphic design of a face.

11. The face covering of claim 2, wherein each ear panel defines a plurality of openings therethrough to facilitate fitting each said ear panel over an ear of the user.

12. The face covering of claim 2, wherein at least one of the openings defined through each ear panel is formed as a slit cut through the ear panel.

13. The face covering of claim 1, wherein the fabric material includes elastic material.

14. The face covering of claim 1, wherein the fabric material includes a woven fabric material.

15. The face covering of claim 1, wherein the fabric material includes a non-woven fabric material.

16. The face covering of claim 1 further comprising:
a first tie extending laterally away from the planar body portion along a first direction; and
a second tie extending laterally away from the planar body portion along a second direction, the second direction being generally opposite to the first direction.

17. A method of making the face covering of claim 1 comprising:
supplying fabric material; and
cutting out a blank from the fabric material, the blank having a shape of the planar body portion, the first ear panel, and the second ear panel.

18. The method of claim 17, wherein the cutting out the blank is carried out by way of die cutting operation.

19. The method of claim 17 further comprising:
printing indicia on at least a portion of the blank.
